(19) United States
(12) Patent Application Publication
(10) Pub. No.: US 2014/0286320 A1
(43) Pub. Date: Sep. 25, 2014

(54) METHOD AND APPARATUS FOR INDICATING TRANSMISSION TIME INTERVAL

(71) Applicant: HUAWEI TECHNOLOGIES CO., LTD., Shenzhen (CN)

(72) Inventor: Chuanfeng HE, Beijing (CN)

(21) Appl. No.: 14/298,071

(22) Filed: Jun. 6, 2014

Related U.S. Application Data
(63) Continuation of application No. PCT/CN2012/085111, filed on Nov. 23, 2012.

(30) Foreign Application Priority Data
Dec. 9, 2011 (CN) 201110409239.0

(51) Int. Cl. H04L 5/00; H04W 74/08

(52) U.S. Cl. CPC H04L 5/0053; H04W 74/0833; H04L 5/0055
USPC 370/336

(57) ABSTRACT

Embodiments of the present invention disclose a method and an apparatus for indicating a transmission time interval. The implementation solutions of the method includes: receiving an access preamble from a user equipment UE, where the access preamble carries a signature; determining whether a cell where the UE is located is configured with an extended acquisition indicator EAI, and sending, on an acquisition indicator channel AICH of an access timeslot corresponding to an access timeslot where the access preamble is received, an acquisition indicator AI corresponding to the signature of the access preamble. Therefore, the problem that the judging condition of EAI configured is always YES is solved; the UE access delay may be reduced; the number of preambles sent by the UE may be reduced; and interference on the uplink may be reduced.

### CROSS-REFERENCE TO RELATED APPLICATIONS

This application is a continuation of International Application No. PCT/CN2012/085111 filed on Nov. 23, 2012, which claims priority to Chinese Patent Application No. 201110409239.0, filed on Dec. 9, 2011, both of which are hereby incorporated by reference in their entireties.

### TECHNICAL FIELD

Various embodiments of the present invention relate to the field of communication technologies, and in particular, to a method and an apparatus for indicating a transmission time interval.

### BACKGROUND

A 3GPP (3rd Generation Partnership Project) WCDMA (wideband code division multiple access) R8 introduces an enhanced uplink feature, that is, allowing a UE (user equipment) in CELL-FACH (cell forward access channel) and idle states to obtain E-DCH (enhanced dedicated channel) resources through enhanced random access to replace the RACH (random access channel) in an R99 to implement uplink transmission, so as to reduce the uplink transmission delay of the UE and improve the uplink transmission rate.

In the R8, TTI (transmission time interval) types of E-DCH uplink transmission of the UE in the CELL-FACH and idle states include two types: 10 ms TTI and 2 ms TTI, and the E-DCH respectively uses the 10 ms and 2 ms transmission time intervals to perform uplink transmission. In the R8, the TTI types are configured by the network side, and each cell is fixedly configured with one TTI type. When the UE in the CELL-FACH and idle states initiates enhanced uplink access, E-DCH transmission uses the TTI type configured in the cell where the E-DCH is located.

In the R8, after a base station detects a preamble signature (access preamble signature) sent by a UE, the base station indicates common (common) E-DCH resources to the UE through an AICH (Acquisition Indicator Channel, acquisition indicator channel) and the specific procedure is as follows: When the UE detects that the value of an AI (Acquisition Indicator, acquisition indicator) carried by the AICH and corresponding to the sent signature (signature) is +1, it indicates that the base station instructs the UE to use default common E-DCH resources associated with the signature. When the UE detects that the value of the AI carried by the AICH and corresponding to the sent signature is −1, the UE judges whether the cell is configured with an EAI (Extended Acquisition Indicator, extended acquisition indicator); and if so, a common E-DCH resource index is obtained by detecting the EAI; or if not, it indicates that the base station NACK (rejects) the access request of the UE, and the UE ends the access process.

In an R11, the CELL-FACH state is continuously enhanced, including allowing the two TTI types of 10 ms TTI and 2 ms TTI to coexist. A UE decides, according to information such as a measurement result and data amount sent on the uplink, the TTI type to be used. Meanwhile, signatures of preambles sent by UEs initiating access are classified, where a part of signatures are used by UEs selecting the 10 ms TTI for sending, and a part of signatures are used by UEs selecting the 2 ms TTI for sending. The base station knows, according to a detected preamble signature, the TTI type of the E-DCH resources requested by a UE. The UE selects a TTI type and a signature in a signature set corresponding to the TTI type to initiate access. When a Node B (base station) detects the preamble of the UE, the NodeB decides, according to situations such as uplink interference and resource allocation, whether the UE is allowed to use the requested TTI length, and then indicates, in a certain mode, to the UE whether the UE is allowed to use the requested TTI length, for example, the common E-DCH resources used by the UE and TTI type information are indicated through the AICH. In addition, in the process, if the Node B discovers, in some cases, that no common E-DCH resource can be allocated, the Node B may indicate the UE to perform a fallback, and the UE executes a fallback operation, and performs PRACH (physical random access channel) access in an R99 mode.

When the base station detects the preamble signature sent by the UE, the base station, by using an AICH response and the AICH value and EAI configured, judges and indicates whether the TTI type used by the UE is 2 ms TTI or 10 ms TTI. The specific indication process is:

when the acquisition indicator AI is +1 and no EAI is configured, indicating that the UE uses associated default resources and the TTI type requested by the UE;

when the acquisition indicator AI is +1 and the EAI is configured, indicating, through the EAI, the resource index used by the UE and another TTI type different from the TTI type requested by the UE;

when the acquisition indicator AI is −1 and no EAI is configured, indicating rejection of the access request of the UE, namely, NACK (negative acknowledgement); and

when the acquisition indicator AI is −1 and the EAI is configured, indicating, through the EAI, the resource index used by the UE and the TTI type requested by the UE.

In the process of implementing various embodiments of the present invention, the prior art has the following disadvantages: According to the above solution, the TTI type used by the UE is indicated by judging the AICH value and EAI configured (configured). For the judging condition of EAI configured, because the EAI is configured at the cell level, for R11 system the cell is configured with the EAI, and the judging condition of EAI configured is always YES (yes). In other words, no matter whether the AICH value is +1 or −1, an R11 UE needs to read the EAI to obtain resources; even though the associated default resources are idle, the resources need to be indicated through the EAI, and resources can be indicated for only one UE through the EAI. Therefore, when the Node B needs to respond to access of multiple R11 UEs supporting TTI selection, the Node B cannot directly instruct, through the AI, the multiple R11 UEs to obtain default resources, and can only indicate the UEs one by one through the EAI, and the UEs not instructed need to resend a preamble to wait for the acquisition indicator of the base station. Therefore, the solution causes a longer UE access delay, and because the number of preambles to be sent by the UE increases, extra interference is also caused to the uplink.

### SUMMARY

Various embodiments of the present invention provide a method and an apparatus for indicating a transmission time interval, which are used to reduce the UE access delay, reduce the number of preambles sent by the UE, and reduce interference on the uplink.

A method for indicating a transmission time interval includes:

receiving an access preamble from a user equipment (UE), where the access preamble carries a signature; and

determining whether a cell where the UE is located is configured with an extended acquisition indicator (EAI), and sending, on an acquisition indicator channel (AICH) of an access timeslot corresponding to an access timeslot where the access preamble is received, an acquisition indicator (AI) corresponding to the signature of the access preamble; where

if a value of the AI is a first value, default resources associated with the signature of the access preamble which are used by the UE and a transmission time interval (TTI) type requested by the UE are allocated and indicated, or default resources associated with the AI corresponding to the signature of the access preamble which are used by the UE and a TTI type requested by the UE are allocated and indicated.

A method for indicating a transmission time interval includes:

sending an access preamble to a base station, where the access preamble carries a signature; and determining whether a cell where a user equipment (UE) is located is configured with an extended acquisition indicator (EAI); and

receiving, on an acquisition indicator channel (AICH) of an access timeslot corresponding to an access timeslot where the access preamble is sent, an acquisition indicator (AI) from the base station and corresponding to the signature of the access preamble; where

if a value of the AI is a first value, default resources associated with the signature of the access preamble which are used by the UE and a transmission time interval (TTI) type requested by the UE are indicated, or default resources associated with the AI corresponding to the signature of the access preamble which are used by the UE and a TTI type requested by the UE are allocated and indicated.

A base station includes:

a preamble receiving unit, configured to receive an access preamble from a user equipment (UE), where the access preamble carries a signature;

a configuration determining unit, configured to determine whether a cell where the UE is located is configured with an extended acquisition indicator (EAI); and

an indicator sending unit, configured to send, on an acquisition indicator channel (AICH) of an access timeslot corresponding to an access timeslot where the access preamble is received, an acquisition indicator (AI) corresponding to the signature of the access preamble; where

if a value of the AI is a first value, default resources associated with the signature of the access preamble which are used by the UE and a transmission time interval (TTI) type requested by the UE are allocated and indicated, or default resources associated with the AI corresponding to the signature of the access preamble which are used by the UE and a TTI type requested by the UE are allocated and indicated.

A user equipment includes:

a preamble sending unit, configured to send an access preamble to a base station, where the access preamble carries a signature;

a configuration determining unit, configured to determine whether a cell where the user equipment (UE) is located is configured with an extended acquisition indicator (EAI); and

an indicator receiving unit, configured to receive, on an acquisition indicator channel (AICH) of an access timeslot corresponding to an access timeslot where the access preamble is sent, an acquisition indicator (AI) from the base station and corresponding to the signature of the access preamble; where

if a value of the AI is a first value, default resources associated with the signature of the access preamble which are used by the UE and a transmission time interval (TTI) type requested by the UE are indicated, or default resources associated with the AI corresponding to the signature of the access preamble which are used by the UE and a TTI type requested by the UE are allocated and indicated.

As seen from the above technical solutions, various embodiments of the present invention have the following advantages: By determining whether a cell is configured with an EAI, one AI or EAI is used to indicate whether the access request of the UE is rejected, and indicate the TTI type, indicate the resource index used by the UE, indicate the UE to execute a fallback operation, and indicate the UE to use default resources. Therefore, the problem that the judging condition of EAI configured is always YES (yes) is solved; the UE access delay may be reduced; the number of preambles sent by the UE may be reduced; and interference on the uplink may be reduced.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some of the embodiments of the present invention, and persons of ordinary skill in the art may still derive other drawings from these accompanying drawings without creative efforts.

FIG. 1 is a schematic flowchart of a method according to an embodiment of the present invention;

FIG. 2 is a schematic flowchart of another method according to an embodiment of the present invention;

FIG. 3 is a schematic flowchart of a sequence for executing a method according to an embodiment of the present invention;

FIG. 4 is a schematic structural diagram of a base station according to an embodiment of the present invention;

FIG. 5 is a schematic structural diagram of a user equipment according to an embodiment of the present invention; and

FIG. 6 is a schematic structural diagram of a system according to an embodiment of the invention.

### DESCRIPTION OF EMBODIMENTS

To make the objectives, technical solutions, and advantages of various embodiments of the present invention more comprehensible, the following further describes various embodiments of the present invention with reference to the accompanying drawings. Apparently, the embodiments described herein are merely a part rather than all of the embodiments of the present invention. All other embodiments obtained by persons of ordinary skill in the art based on the embodiments of the present invention without creative efforts shall fall within the protection scope of the present invention.

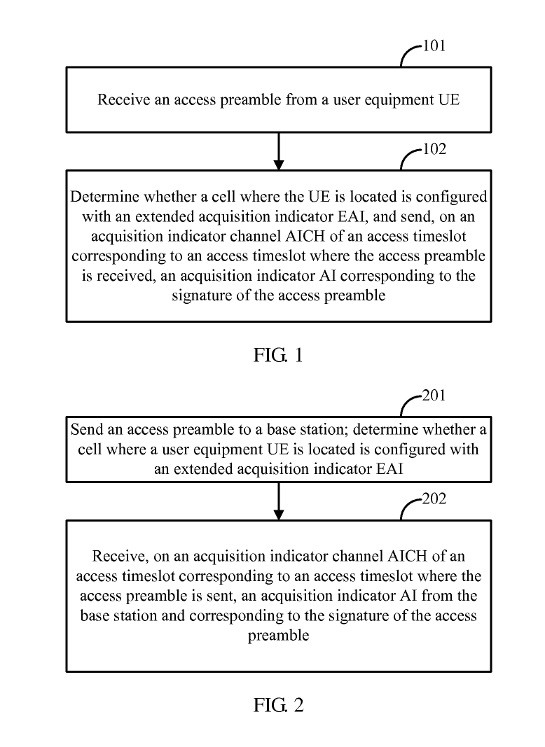

An embodiment of the present invention provides a method for indicating a transmission time interval. As shown in FIG. 1, the solution is applied to a base station side and includes:

101. receiving an access preamble from a user equipment UE, where the access preamble carries a signature (signature); and

102. determining whether a cell where the UE is located is configured with an extended acquisition indicator EAI, and sending, on an acquisition indicator channel AICH of an access timeslot corresponding to an access timeslot where the access preamble is received, an acquisition indicator AI corresponding to the signature of the access preamble; where

if a value of the AI is a first value, default resources associated with the signature of the access preamble which are used by the UE and a transmission time interval TTI type requested by the UE are allocated and indicated, or default resources associated with the AI corresponding to the signature of the access preamble which are used by the UE and a transmission time interval TTI type requested by the UE are allocated and indicated;

if the cell where the UE is located is configured with no EAI and the value of the AI is a second value, rejection of an access request of the UE is indicated, where the rejection of the access request of the UE may be implemented by sending a negative acknowledgement (NACK) to the UE; or

if the cell where the UE is located is configured with an EAI and the value of the AI is the second value, an EAI is sent to indicate rejection of the access request of the UE, or allocate and indicate a resource index used by the UE and a TTI type, or indicate the UE to execute a fallback operation.

The relationship between the access timeslot where the access preamble is received and the corresponding access timeslot is as follows: A fixed time relationship exists between the access timeslot where the UE sends the access preamble (namely, the access timeslot where the base station receives the access preamble) and the access timeslot where the UE receives the AICH carrying the corresponding AI (namely, the corresponding timeslot), that is, the two access timeslots have a corresponding relationship due to the fixed time relationship. After the UE sends an access preamble at an uplink access timeslot making reference to the UE itself, the UE receives an AI at the corresponding downlink access timeslot; correspondingly, the base station sends the AI at the corresponding downlink access timeslot after receiving the access preamble at the uplink access timeslot.

The signature carried in the AICH and the access preamble signature have a mapping relationship, where the mapping relationship is used to respond to the received access preamble through the AI corresponding to the signature; the UE receives, at the access timeslot corresponding to the access timeslot where the access preamble is sent, the AI corresponding to the preamble signature, so as to judge whether the base station has sent the corresponding AI.

It should be noted that the above “first value” and “second value” are used to distinguish two different values, and do not represent other meanings. Preferably, for better compatibility with the current standard, the first value is +1 and the second value is −1; if the value of the AI is the first value, allocating and indicating default resources associated with the signature of the access preamble which are used by the UE and a transmission time interval TTI type requested by the UE, or allocating and indicating default resources associated with the AI corresponding to the signature of the access preamble which are used by the UE and a transmission time interval TTI type requested by the UE, includes: when the value of the AI is +1, allocating and indicating default resources associated with the signature of the access preamble which are used by the UE and a transmission time interval TTI type requested by the UE, or allocating and indicating default resources associated with the AI corresponding to the signature of the access preamble which are used by the UE and a transmission time interval TTI type requested by the UE.

If the cell where the UE is located is configured with no EAI, and the value of the AI is the second value, indicating rejection of the access request of the UE, includes: if the value of the AI is −1, and the cell where the UE is located is configured with no EAI, indicating rejection of the access request of the UE.

If the cell where the UE is located is configured with an EAI and the value of the AI is the second value, sending an EAI to indicate rejection of the access request of the UE, or allocate and indicate a resource index used by the UE and a TTI type, or indicate the UE to execute a fallback operation, includes: if the value of the AI is −1, and the cell where the UE is located is configured with an EAI, sending an EAI to indicate rejection of the access request of the UE, or allocate and indicate a resource index used by the UE and a TTI type, or indicate the UE to execute a fallback operation.

With the solution of the embodiment of the present invention, by determining whether a cell is configured with an EAI, one AI or EAI is used to indicate whether the access request of the UE is rejected, and indicate the TTI type, indicate the resource index used by the UE, indicate the UE to execute a fallback operation, and indicate the UE to use default resources. Therefore, the problem that the judging condition of EAI configured is always YES (yes) is solved; the UE access delay may be reduced; the number of preambles sent by the UE may be reduced; and interference on the uplink may be reduced.

With respect to the implementation solutions of sending an EAI to indicate rejection of the access request of the UE, or allocate and indicate a resource index used by the UE and a TTI type, or indicate the UE to execute a fallback operation in step 102 of the above solution, the embodiment of the present invention provides three implementation examples. It should be noted that the following three solutions are preferred implementation solutions but not the exhaustive enumeration of implementation solutions and should not be understood as a limitation on the embodiment of the present invention. The specific solutions are as follows:

Solution 1

sending one EAI, which is used to indicate rejection of the access request of the UE, or allocate and indicate a resource index used by the UE and mapped by the EAI and a TTI type requested by the UE;

sending two EAIs, where one EAI is a rejection NACK, used to allocate and indicate a resource index used by the UE and mapped by another EAI, and another TTI type different from the TTI type requested by the UE, or a preset TTI type; or

sending two EAIs, where the two EAIs do not include a NACK, or sending more than two EAIs used to indicate the UE to execute the fallback operation.

Solution 2

sending one EAI, which is used to indicate rejection of the access request of the UE, or indicate the UE to execute the fallback operation, or allocate and indicate a resource index used by the UE and mapped by the EAI and a TTI type requested by the UE; or

sending two EAIs, where one is a TTI type indicator, and the other is an EAI indicating the resource index used by the UE, where the two EAIs are respectively used to indicate the resource index used by the UE, and another TTI type different from the TTI type requested by the UE, or a preset TTI type.

Solution 3

sending one EAI, which is used to indicate rejection of the access request of the UE, or indicate the UE to execute the fallback operation, or indicate a resource index used by the UE and indicated by the EAI and a TTI type requested by the UE; or

sending two EAIs, where one is a TTI type or fallback indicator, and the other is an EAI indicating the resource index used by the UE, where the two EAIs are respectively used to allocate and indicate the resource index used by the UE, and another TTI type different from the TTI type requested by the UE, or a preset TTI type.

Corresponding to the implementation solution at the base station side, an embodiment of the present invention also provides another method for indicating a transmission time interval. As shown in FIG. 2, the solution is applied to a user equipment side and includes:

201. sending an access preamble to a base station, where the access preamble carries a signature; and determining whether a cell where a user equipment UE is located is configured with an extended acquisition indicator EAI; and

202. receiving, on an acquisition indicator channel AICH of an access timeslot corresponding to an access timeslot where the access preamble is sent, an acquisition indicator AI from the base station and corresponding to the signature of the access preamble; where

if a value of the AI is a first value, default resources associated with the signature of the access preamble which are used by the UE and a transmission time interval TTI type requested by the UE are indicated, or default resources associated with the AI corresponding to the signature of the access preamble which are used by the UE and a transmission time interval TTI type requested by the UE are allocated and indicated;

if the cell where the UE is located is configured with no EAI, and the value of the AI is a second value, rejection of the access request of the UE is indicated; or

if the cell where the UE is located is configured with an EAI and the value of the AI is the second value, an EAI is received, where the EAI indicates rejection of the access request of the UE, or indicates a resource index used by the UE and a TTI type, or instructs the UE to execute a fallback operation.

It should be noted that the above “first value” and “second value” are used to distinguish two different values, and do not represent other meanings. Preferably, for better compatibility with the current standard, the first value is +1 and the second value is −1; if the value of the AI is the first value, indicating default resources associated with the signature of the access preamble which are used by the UE and a transmission time interval TTI type requested by the UE, or allocating and indicating default resources associated with the AI corresponding to the signature of the access preamble which are used by the UE and a transmission time interval TTI type requested by the UE, includes: when the value of the AI is +1, indicating default resources associated with the signature of the access preamble which are used by the UE and a transmission time interval TTI type requested by the UE, or allocating and indicating default resources associated with the AI corresponding to the signature of the access preamble which are used by the UE and a transmission time interval TTI type requested by the UE.

If the cell where the UE is located is configured with no EAI, and the value of the AI is the second value, indicating rejection of the access request of the UE, includes: if the value of the AI is −1, and the cell where the UE is located is configured with no EAI, indicating rejection of the access request of the UE.

If the value of the AI is −1, and the cell where the UE is located is configured with an EAI, receiving an EAI which indicates rejection of the access request of the UE, or allocate and indicate a resource index used by the UE and a TTI type, or indicate the UE to execute a fallback operation, if the cell where the UE is located is configured with an EAI and the value of the AI is the second value, includes: receiving an EAI which indicates rejection of the access request of the UE, or allocate and indicate a resource index used by the UE and a TTI type, or indicate the UE to execute a fallback operation.

With respect to the implementation solutions of receiving an EAI which indicates rejection of the access request of the UE, or allocates and indicates a resource index used by the UE and a TTI type, or instructs the UE to execute a fallback operation in step 202 of the above solution, the embodiment of the present invention provides three implementation examples. It should be noted that the following three solutions are preferred implementation solutions but not the exhaustive enumeration of implementation solutions and should not be understood as a limitation on the embodiment of the present invention. The specific solutions are as follows:

Solution 1

if one EAI is received, the EAI is used to indicate rejection of the access request of the UE, or indicate a resource index used by the UE and mapped by the EAI and the TTI type requested by the UE;

if two EAIs are received and one EAI is a rejection NACK, indicating a resource index used by the UE and mapped by another EAI, and another TTI type different from the TTI type requested by the UE, or a preset TTI type; or

if two EAIs are received and the two EAIs do not include a NACK, or more than two EAIs are received, instructing the UE to execute the fallback operation.

Solution 2

if one EAI is received, the EAI is used to indicate rejection of the access request of the UE, or indicate the UE to execute the fallback operation, or indicate a resource index used by the UE and mapped by the EAI and the TTI type requested by the UE; or

if two EAIs are received and one is a TTI type indicator, and the other is an EAI indicating the resource index used by the UE, the two EAIs are respectively used to indicate the resource index used by the UE, and another TTI type different from the TTI type requested by the UE, or a preset TTI type.

Solution 3

if one EAI is received, the EAI is used to indicate rejection of the access request of the UE, or indicate the UE to execute the fallback operation, or indicate a resource index used by the UE and indicated by the EAI and the TTI type requested by the UE; or

if two EAIs are received, where one is a TTI type or fallback indicator, and the other is an EAI indicating the resource index used by the UE, the two EAIs are respectively used to indicate the resource index used by the UE, and another TTI type different from the TTI type requested by the UE, or a preset TTI type.

The three implementation solutions implemented on the base station side correspond to those on the user equipment side in sequence. The subsequent embodiments describe the sequence of executing the three solutions in more detail. In the description process, the judgment on the UE side is used as an example, and the setting on the base station side corresponds to that on the UE side and is not further described herein. In the following three embodiments, the specific implementation solutions in the above embodiment are described through examples: sending an EAI to indicate the UE to execute a fallback operation includes: defining an EAI to indicate the UE to execute a fallback operation. Sending two EAIs, where one is a TTI type indicator, includes: defining an EAI to indicate another TTI type different from the requested TTI type and used by the UE, or a fixed TTI type. Sending two EAIs, where one is a TTI type or fallback indicator, includes: defining an EAI to indicate the UE to use a TTI type or execute a fallback.

The execution sequence of solution 1: The solution may use the resource configuration mapping shown in Table 1, where the table is as follows:

TABLE 1
Mapping between EAIs and resource configuration

| | | E-DCH Resource |
|---|---|---|
| | Signature | Configuration Index |
| EAIs′ | s′ | (Configuration Index Number) |
| +1 | 0 | NACK |
| −1 | | (X + 1) mod Y |
| +1 | 1 | (X + 2) mod Y |
| −1 | | (X + 3) mod Y |
| +1 | 2 | (X + 4) mod Y |
| −1 | | (X + 5) mod Y |
| +1 | 3 | (X + 6) mod Y |
| −1 | | (X + 7) mod Y |
| +1 | 4 | (X + 8) mod Y |
| −1 | | (X + 9) mod Y |
| +1 | 5 | (X + 10) mod Y |
| −1 | | (X + 11) mod Y |
| +1 | 6 | (X + 12) mod Y |
| −1 | | (X + 13) mod Y |
| +1 | 7 | (X + 14) mod Y |
| −1 | | (X + 15) mod Y |
| +1 | 8 | (X + 16) mod Y |
| −1 | | (X + 17) mod Y |
| +1 | 9 | (X + 18) mod Y |
| −1 | | (X + 19) mod Y |
| +1 | 10 | (X + 20) mod Y |
| −1 | | (X + 21) mod Y |
| +1 | 11 | (X + 22) mod Y |
| −1 | | (X + 23) mod Y |
| +1 | 12 | (X + 24) mod Y |
| −1 | | (X + 25) mod Y |
| +1 | 13 | (X + 26) mod Y |
| −1 | | (X + 27) mod Y |
| +1 | 14 | (X + 28) mod Y |
| −1 | | (X + 29) mod Y |
| +1 | 15 | (X + 30) mod Y |
| −1 | | (X + 31) mod Y |

In the above Table 1, the number of signatures in the EAI part is 16, the combination of values (+1 or −1) of different EAIs' of each signature s′ may include 32 EAI signatures. At a given access timeslot, the base station can indicate at most one of the 32 EAI signatures, that is, carry at most one signature with the EAI not being 0. In the 32 EAI signatures, when s′=0 and when EAI0=+1, the EAI signature indicates a NACK, and the remaining signatures may indicate the index of uplink E-DCH resources. The index is obtained according to the default resource index associated with the signature of the access preamble to which the base station responds through the AI plus an offset, and the combination of different signatures carried by the EAI part and EAIs indicates different resource index offsets. After the UE receives the EAI, the UE may calculate, through the indicated offset, the resource index indicated by the base station. The resource indicator relationship is shown in Table 1, where X indicates the default resource index associated with the signature of the access preamble to which the base station responds through the AI, and Y indicates the total number of common E-DCH resources in the cell.

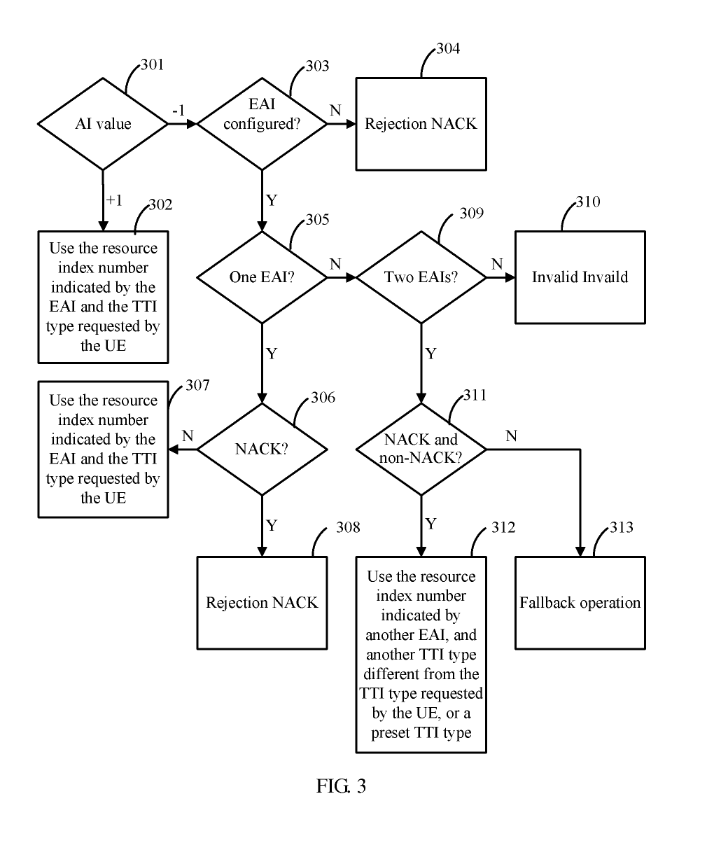

As shown in FIG. 3, the execution sequence includes:

301. obtaining an AI value from an AICH; and if the value is +1, going to 302; or if the value is −1, going to 303;

302. using the resource index indicated by the EAI and the TTI type requested by the UE;

303. determining whether an EAI is configured; and if so (Y), going to 305, or if not (N), going to 304;

304. indicating rejection (NACK) of the access request of the UE;

305. judging whether there is only one EAI, and if so, going to 306, or if not, going to 309;

306. determining whether the EAI is a NACK; and if so, going to 308, or if not, going to 307;

307. indicating the resource index used by the UE and indicated by the EAI and the TTI type requested by the UE;

308. indicating rejection (NACK) of the access request of the UE;

309. determining whether there are two EAIs, and if not, going to 310, or if so, going to 311;

310. indicating to the UE that resources are invalid;

311. if there are two EAIs, determining whether there are NACK and non-NACK EAIs, and if so, going to 312, or if not, going to 313;

312. indicating the resource index used by the UE and indicated by another EAI, and another TTI type different from the TTI type requested by the UE, or a preset TTI type; and

313. if there are two EAIs, and the two EAIs do not include a NACK, or there are more than two EAIs, instructing the UE to execute a fallback operation.

The difference between solution 2 and solution 1 lies in that: Among 32 EAIs in solution 2, one EAI is defined for indicating the TTI type, and one EAI is defined for indicating a fallback, and at most two EAIs may be sent. Specifically as shown in Table 2, X indicates the default resource index associated with the signature of the access preamble to which the base station responds through the AI, and Y indicates the total number of common E-DCH resources in the cell:

TABLE 2

| | Signature | E-DCH Resource |
|---|---|---|
| EAIs′ | s′ | Configuration Index |
| +1 | 0 | NACK |
| −1 | | Fallback indicator |
| +1 | 1 | TTI indicator |
| −1 | | (X + 1) mod Y |
| +1 | 2 | (X + 2) mod Y |
| −1 | | (X + 3) mod Y |
| +1 | 3 | (X + 4) mod Y |
| −1 | | (X + 5) mod Y |
| +1 | 4 | (X + 6) mod Y |
| −1 | | (X + 7) mod Y |
| +1 | 5 | (X + 8) mod Y |
| −1 | | (X + 9) mod Y |
| +1 | 6 | (X + 10) mod Y |
| −1 | | (X + 11) mod Y |
| +1 | 7 | (X + 12) mod Y |
| −1 | | (X + 13) mod Y |
| +1 | 8 | (X + 14) mod Y |
| −1 | | (X + 15) mod Y |
| +1 | 9 | (X + 16) mod Y |
| −1 | | (X + 17) mod Y |
| +1 | 10 | (X + 18) mod Y |
| −1 | | (X + 19) mod Y |
| +1 | 11 | (X + 20) mod Y |
| −1 | | (X + 21) mod Y |
| +1 | 12 | (X + 22) mod Y |
| −1 | | (X + 23) mod Y |
| +1 | 13 | (X + 24) mod Y |
| −1 | | (X + 25) mod Y |
| +1 | 14 | (X + 26) mod Y |
| −1 | | (X + 27) mod Y |
| +1 | 15 | (X + 28) mod Y |
| −1 | | (X + 29) mod Y |

The difference between solution 3 and solution 1 lies in that: Among 32 EAIs in solution 3, only one EAI is defined for indicating the TTI type or fallback, and at most two EAIs may be sent. As shown in Table 3, X indicates the default resource index associated with the signature of the access preamble to which the base station responds through the AI, and Y indicates the total number of common E-DCH resources in the cell.

TABLE 3

| | Signature | E-DCH Resource |
|---|---|---|
| EAIs′ | s′ | Configuration Index |
| +1 | 0 | NACK |
| −1 | | Fallback or TTI indicator |
| +1 | 1 | (X + 1) mod Y |
| −1 | | (X + 2) mod Y |
| +1 | 2 | (X + 3) mod Y |
| −1 | | (X + 4) mod Y |
| +1 | 3 | (X + 5) mod Y |
| −1 | | (X + 6) mod Y |
| +1 | 4 | (X + 7) mod Y |
| −1 | | (X + 8) mod Y |
| +1 | 5 | (X + 9) mod Y |
| −1 | | (X + 10) mod Y |
| +1 | 6 | (X + 11) mod Y |
| −1 | | (X + 12) mod Y |
| +1 | 7 | (X + 13) mod Y |
| −1 | | (X + 14) mod Y |
| +1 | 8 | (X + 15) mod Y |
| −1 | | (X + 16) mod Y |
| +1 | 9 | (X + 17) mod Y |
| −1 | | (X + 18) mod Y |
| +1 | 10 | (X + 19) mod Y |
| −1 | | (X + 20) mod Y |
| +1 | 11 | (X + 21) mod Y |
| −1 | | (X + 22) mod Y |
| +1 | 12 | (X + 23) mod Y |
| −1 | | (X + 24) mod Y |
| +1 | 13 | (X + 25) mod Y |
| −1 | | (X + 26) mod Y |
| +1 | 14 | (X + 27) mod Y |
| −1 | | (X + 28) mod Y |
| +1 | 15 | (X + 29) mod Y |
| −1 | | (X + 30) mod Y |

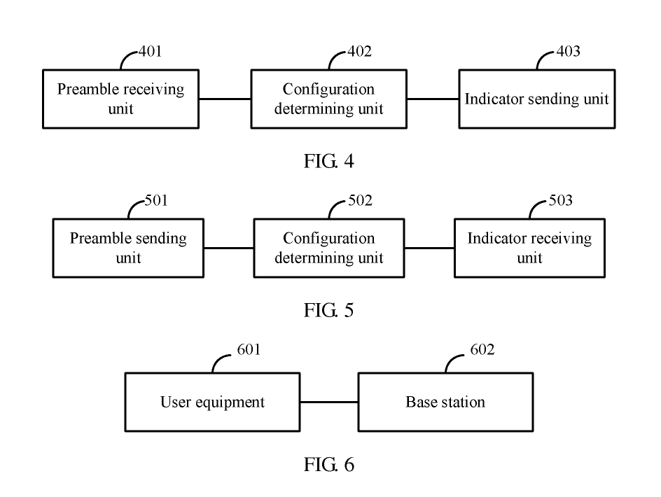

An embodiment of the present invention also provides a base station, as shown in FIG. 4, including:

a preamble receiving unit 401, configured to receive an access preamble from a user equipment UE, where the access preamble carries a signature;

a configuration determining unit 402, configured to determine whether a cell where the UE is located is configured with an extended acquisition indicator EAI; and

an indicator sending unit 403, configured to send, on an acquisition indicator channel AICH of an access timeslot corresponding to an access timeslot where the access preamble is received, an acquisition indicator AI corresponding to the signature of the access preamble; where

if a value of the AI is a first value, default resources associated with the signature of the access preamble which are used by the UE and a transmission time interval TTI type requested by the UE are allocated and indicated, or default resources associated with the AI corresponding to the signature of the access preamble which are used by the UE and a transmission time interval TTI type requested by the UE are allocated and indicated;

if the cell where the UE is located is configured with no EAI, and the value of the AI is a second value, rejection of the access request of the UE is indicated; or

if the cell where the UE is located is configured with an EAI and the value of the AI is the second value, an EAI is sent to indicate rejection of the access request of the UE, or allocate and indicate a resource index used by the UE and a TTI type, or indicate the UE to execute a fallback operation.

With the solution of the embodiment of the present invention, by determining whether a cell is configured with an EAI, one AI or EAI is used to indicate whether the access request of the UE is rejected, and indicate the TTI type, indicate the resource index used by the UE, indicate the UE to execute a fallback operation, and indicate the UE to use default resources. Therefore, the problem that the judging condition of EAI configured is always YES (yes) is solved; the UE access delay may be reduced; the number of preambles sent by the UE may be reduced; and interference on the uplink may be reduced.

Optionally, the indicator sending unit 403 being configured to send an EAI to indicate rejection of the access request of the UE, or allocate and indicate a resource index used by the UE and a TTI type, or indicate the UE to execute a fallback operation, includes:

sending one EAI, which is used to indicate rejection of the access request of the UE, or allocate and indicate a resource index used by the UE and mapped by the EAI and the TTI type requested by the UE;

sending two EAIs, where one EAI is a rejection NACK, used to allocate and indicate a resource index used by the UE and mapped by another EAI, and another TTI type different from the TTI type requested by the UE, or a preset TTI type; or

sending two EAIs, where the two EAIs do not include a NACK, or sending more than two EAIs used to indicate the UE to execute the fallback operation.

Optionally, the indicator sending unit 403 being configured to send an EAI to indicate rejection of the access request of the UE, or allocate and indicate a resource index used by the UE and a TTI type, or indicate the UE to execute a fallback operation, includes:

sending one EAI, which is used to indicate rejection of the access request of the UE, or indicate the UE to execute the fallback operation, or allocate and indicate a resource index used by the UE and mapped by the EAI and the TTI type requested by the UE; or

sending two EAIs, where one is a TTI type indicator, and the other is an EAI indicating the resource index used by the UE, where the two EAIs are respectively used to indicate the resource index used by the UE, and another TTI type different from the TTI type requested by the UE, or a preset TTI type.

Optionally, the indicator sending unit 403 being configured to send an EAI to indicate rejection of the access request of the UE, or allocate and indicate a resource index used by the UE and a TTI type, or indicate the UE to execute a fallback operation, includes:

sending one EAI, which is used to indicate rejection of the access request of the UE, or indicate the UE to execute the fallback operation, or indicate a resource index used by the UE and indicated by the EAI and the TTI type requested by the UE; or

sending two EAIs, where one is a TTI type or fallback indicator, and the other is an EAI indicating the resource index used by the UE, where the two EAIs are respectively used to allocate and indicate the resource index used by the UE, and another TTI type different from the TTI type requested by the UE, or a preset TTI type.

An embodiment of the present invention also provides a user equipment, as shown in FIG. 5, including:

a preamble sending unit 501, configured to send an access preamble to a base station, where the access preamble carries a signature;

a configuration determining unit 502, configured to determine whether a cell where the user equipment UE is located is configured with an extended acquisition indicator EAI; and

an indicator receiving unit 503, configured to receive, on an acquisition indicator channel AICH of an access timeslot corresponding to an access timeslot where the access preamble is sent, an acquisition indicator AI from the base station and corresponding to the signature of the access preamble; where

if a value of the AI is a first value, default resources associated with the signature of the access preamble which are used by the UE and a transmission time interval TTI type requested by the UE are indicated, or default resources associated with the AI corresponding to the signature of the access preamble which are used by the UE and a transmission time interval TTI type requested by the UE are allocated and indicated;

if the cell where the UE is located is configured with no EAI, and the value of the AI is a second value, rejection of the access request of the UE is indicated; or

if the cell where the UE is located is configured with an EAI and the value of the AI is the second value, an EAI which indicates rejection of the access request of the UE, or indicates a resource index used by the UE and a TTI type, or instructs the UE to execute a fallback operation is received.

It should be noted that the indicator receiving unit 503 being configured to receive an EAI which indicates rejection of the access request of the UE, or indicates a resource index used by the UE and a TTI type, or instructs the UE to execute a fallback operation, may be specifically implemented in three optional modes:

Solution 1

if one EAI is received, the EAI is used to indicate rejection of the access request of the UE, or indicate a resource index used by the UE and mapped by the EAI and the TTI type requested by the UE;

if two EAIs are received and one EAI is a rejection NACK, indicating a resource index used by the UE and mapped by another EAI, and another TTI type different from the TTI type requested by the UE, or a preset TTI type; or

if two EAIs are received and the two EAIs do not include a NACK, or more than two EAIs are received, instructing the UE to execute the fallback operation.

Solution 2

if one EAI is received, the EAI is used to indicate rejection of the access request of the UE, or indicate the UE to execute the fallback operation, or indicate a resource index used by the UE and mapped by the EAI and the TTI type requested by the UE; or

if two EAIs are received and one is a TTI type indicator, and the other is an EAI indicating the resource index used by the UE, the two EAIs are respectively used to indicate the resource index used by the UE, and another TTI type different from the TTI type requested by the UE, or a preset TTI type.

Solution 3

if one EAI is received, the EAI is used to indicate rejection of the access request of the UE, or indicate the UE to execute the fallback operation, or indicate a resource index used by the UE and indicated by the EAI and the TTI type requested by the UE; or

if two EAIs are received, where one is a TTI type or fallback indicator, and the other is an EAI indicating the resource index used by the UE, the two EAIs are respectively used to indicate the resource index used by the UE, and another TTI type different from the TTI type requested by the UE, or a preset TTI type.

With the solution of the embodiment of the present invention, by determining whether a cell is configured with an EAI, one AI or EAI is used to indicate whether the access request of the UE is rejected, and indicate the TTI type, indicate the resource index used by the UE, indicate the UE to execute a fallback operation, and indicate the UE to use default resources. Therefore, the problem that the judging condition of EAI configured is always YES (yes) is solved; the UE access delay may be reduced; the number of preambles sent by the UE may be reduced; and interference on the uplink may be reduced.

An embodiment of the present invention also provides a system for indicating a transmission time interval. As shown in FIG. 6, the system includes:

a user equipment 601, configured to send an access preamble to a base station 602, where the access preamble carries a signature; determine whether a cell where the user equipment UE 601 is located is configured with an extended acquisition indicator EAI; receive, on an acquisition indicator channel AICH of an access timeslot corresponding to an access timeslot where the access preamble is sent, an acquisition indicator AI from the base station 602 and corresponding to the signature of the access preamble; and receive the EAI; and

the base station 602, configured to: receive the access preamble from the user equipment UE 601;

determine whether the cell where the UE is located is configured with an extended acquisition indicator EAI, and send, at the acquisition indicator channel AICH of the access timeslot corresponding to the access timeslot where the access preamble is received, an acquisition indicator AI corresponding to the signature of the access preamble, where: if a value of the AI is a first value, default resources associated with the signature of the access preamble which are used by the UE and a transmission time interval TTI type requested by the UE are allocated and indicated, or default resources associated with the AI corresponding to the signature of the access preamble which are used by the UE and a transmission time interval TTI type requested by the UE are allocated and indicated; if the cell where the UE is located is configured with no EAI, and the value of the AI is a second value, rejection of the access request of the UE is indicated; or if the cell where the UE is located is configured with an EAI and the value of the AI is a second value, an EAI is sent to indicate rejection of the access request of the UE, or allocate and indicate a resource index used by the UE and a TTI type, or indicate the UE to execute a fallback operation.

Optionally, the specific optional implementation solution for the base station 602 sending an EAI to indicate rejection of the access request of the UE, or allocate and indicate a resource index used by the UE and a TTI type, or indicate the UE to execute a fallback operation may be:

Solution 1

sending one EAI, which is used to indicate rejection of the access request of the UE, or allocate and indicate a resource index used by the UE and mapped by the EAI and the TTI type requested by the UE;

sending two EAIs, where one EAI is a rejection NACK, used to allocate and indicate a resource index used by the UE and mapped by another EAI, and another TTI type different from the TTI type requested by the UE, or a preset TTI type; or

sending two EAIs, where the two EAIs do not include a NACK, or sending more than two EAIs used to indicate the UE to execute the fallback operation.

Solution 2

sending one EAI, which is used to indicate rejection of the access request of the UE, or indicate the UE to execute the fallback operation, or allocate and indicate a resource index used by the UE and mapped by the EAI and the TTI type requested by the UE; or

sending two EAIs, where one is a TTI type indicator, and the other is an EAI indicating the resource index used by the UE, where the two EAIs are respectively used to indicate the resource index used by the UE, and another TTI type different from the TTI type requested by the UE, or a preset TTI type.

Solution 3

sending one EAI, which is used to indicate rejection of the access request of the UE, or indicate the UE to execute the fallback operation, or indicate a resource index used by the UE and indicated by the EAI and the TTI type requested by the UE; or

sending two EAIs, where one is a TTI type or fallback indicator, and the other is an EAI indicating the resource index used by the UE, where the two EAIs are respectively used to allocate and indicate the resource index used by the UE, and another TTI type different from the TTI type requested by the UE, or a preset TTI type.

With the solution of the embodiment of the present invention, by determining whether a cell is configured with an EAI, one AI or EAI is used to indicate whether the access request of the UE is rejected, and indicate the TTI type, indicate the resource index used by the UE, indicate the UE to execute a fallback operation, and indicate the UE to use default resources. Therefore, the problem that the judging condition of EAI configured is always YES (yes) is solved; the UE access delay may be reduced; the number of preambles sent by the UE may be reduced; and interference on the uplink may be reduced.

It should be noted that the units described in the above UE and base station embodiments are divided only according to the function logic but are not limited to such division. Units that can implement corresponding functions are also applicable. In addition, names of the functional units are for differentiation only and therefore are not intended to limit the protection scope of the present invention.

In addition, persons of ordinary skill in the art may understand that all or part of the steps of the foregoing method embodiments can be implemented by hardware following instructions of programs. The programs may be stored in a computer readable storage medium. The storage medium may be a read only memory, a magnetic disk, or an optical disk.

The foregoing descriptions are merely exemplary specific embodiments of the present invention, but are not intended to limit the protection scope of the present invention. Any variation or replacement figured out by persons skilled in the art within the technical scope disclosed in the embodiments of the present invention shall fall within the protection scope of the present invention. Therefore, the protection scope of the present invention shall be subject to the protection scope of the claims.

What is claimed is:

1. A method comprising:
receiving an access preamble from a user equipment (UE), wherein the access preamble carries a signature; and
determining whether a cell where the UE is located is configured with an extended acquisition indicator (EAI), and sending, on an acquisition indicator channel (AICH) of an access timeslot corresponding to an access timeslot where the access preamble is received, an acquisition indicator (AI) corresponding to the signature of the access preamble; wherein
when a value of the AI is a first value, default resources associated with the signature of the access preamble which are used by the UE and a transmission time interval (TTI) type requested by the UE are allocated and indicated, or default resources associated with the AI corresponding to the signature of the access preamble which are used by the UE and a TTI type requested by the UE are allocated and indicated.

2. The method according to claim 1, wherein the method further comprises: when the cell where the UE is located is configured with no EAI and the value of the AI is a second value, rejection of an access request of the UE is indicated.

3. The method according to claim 1, wherein the method further comprises: when the cell where the UE is located is configured with an EAI and the value of the AI is the second value, sending an EAI to the UE to indicate rejection of the access request of the UE, or allocate and indicate a resource index used by the UE and a TTI type, or indicate the UE to execute a fallback operation.

4. The method according to claim 3, wherein the sending an EAI to the UE to indicate rejection of the access request of the UE, or allocate and indicate a resource index used by the UE and a TTI type, or indicate the UE to execute a fallback operation comprises:
sending one EAI to the UE, wherein when the EAI is NACK, the EAI is used to indicate rejection of the access request of the UE, when the EAI is not NACK, the EAI is used to indicate a resource index used by the UE and mapped by the EAI and the TTI type requested by the UE.

5. The method according to claim 3, wherein the sending an EAI to the UE to indicate rejection of the access request of the UE, or allocate and indicate a resource index used by the UE and a TTI type, or indicate the UE to execute a fallback operation comprises:
sending two EAIs to the UE, wherein when the two EAIs comprises a NACK EAI and a non-NACK EAI, the non-NACK EAI is used to indicate the resource index used by the UE, and another TTI type different from the TTI type requested by the UE, or a preset TTI type, when the two EAIs do not comprise a NACK EAI, the two EAIs are used to instruct the UE to execute a fallback operation.

6. A method comprising:
sending an access preamble to a base station, wherein the access preamble carries a signature; and determining whether a cell where a user equipment (UE) is located is configured with an extended acquisition indicator (EAI); and
receiving, on an acquisition indicator channel (AICH) of an access timeslot corresponding to an access timeslot where the access preamble is sent, an acquisition indicator (AI) from the base station and corresponding to the signature of the access preamble; wherein
when a value of the AI is a first value, default resources associated with the signature of the access preamble which are used by the UE and a transmission time interval (TTI) type requested by the UE are indicated, or default resources associated with the AI corresponding to the signature of the access preamble which are used by the UE and a type requested by the UE are allocated and indicated.

7. The method according to claim 6, wherein the method further comprises: when the cell where the UE is located is configured with no EAI and the value of the AI is a second value, rejection of an access request of the UE is indicated.

8. The method according to claim 6, wherein the method further comprises: the cell where the UE is located is configured with an EAI and the value of the AI is the second value, receiving an EAI which indicates rejection of the access request of the UE, or indicates a resource index used by the UE and a TTI type, or instructs the UE to execute a fallback operation.

9. The method according to claim 6, wherein the receiving an EAI which indicates rejection of the access request of the UE, or indicates a resource index used by the UE and a TTI type, or instructs the UE to execute a fallback operation comprises:
receiving one EAI, wherein when the EAI is NACK, the EAI is used to indicate rejection of the access request of the UE, when the EAI is not NACK, the EAI is used to indicate a resource index used by the UE and mapped by the EAI and the TTI type requested by the UE.

10. The method according to claim 6, wherein the receiving an EAI which indicates rejection of the access request of the UE, or indicates a resource index used by the UE and a TTI type, or instructs the UE to execute a fallback operation comprises:
receiving two EAIs, wherein when the two EAIs comprises a NACK EAI and a non-NACK EAI, the non-NACK EAI is used to indicate the resource index used by the UE, and another TTI type different from the TTI type requested by the UE, or a preset TTI type, when the two EAIs do not comprise a NACK EAI, the two EAIs are used to instruct the UE to execute a fallback operation.

11. A base station, comprising:
a preamble receiving unit, configured to receive an access preamble from a user equipment (UE), wherein the access preamble carries a signature;
a configuration determining unit, configured to determine whether a cell where the UE is located is configured with an extended acquisition indicator (EAI); and
an indicator sending unit, configured to send, on an acquisition indicator channel (AICH) of an access timeslot corresponding to an access timeslot where the access preamble is received, an acquisition indicator (AI) corresponding to the signature of the access preamble; wherein
when a value of the AI is a first value, default resources associated with the signature of the access preamble which are used by the UE and a transmission time interval (TTI) type requested by the UE are allocated and indicated, or default resources associated with the AI corresponding to the signature of the access preamble which are used by the UE and a TTI type requested by the UE are allocated and indicated.

12. The base station according to claim 11, wherein when the cell where the UE is located is configured with no EAI and the value of the AI is a second value, rejection of an access request of the UE is indicated.

13. The base station according to claim 11, wherein when the cell where the UE is located is configured with an EAI and the value of the AI is the second value, the indicator sending unit is configured to send an EAI to the UE to indicate rejection of the access request of the UE, or indicate and allocate a resource index used by the UE and a TTI type, or indicate the UE to execute a fallback operation.

14. The base station according to claim 11, wherein:
the indicator sending unit is configured to send an EAI to the UE to indicate rejection of the access request of the UE, or allocate and indicate a resource index used by the UE and a TTI type, or indicate the UE to execute a fallback operation, comprises:
the indicator sending unit is configured to send one EAI, wherein when the EAI is NACK, the EAI is used to indicate rejection of the access request of the UE, or when the EAI is not NACK, the EAI is used to indicate a resource index used by the UE and mapped by the EAI and the TTI type requested by the UE.

15. The base station according to claim 11, wherein:
the indicator sending unit is configured to send an EAI to the UE to indicate rejection of the access request of the UE, or allocate and indicate a resource index used by the UE and a TTI type, or indicate the UE to execute a fallback operation, comprises:
the indicator sending unit is configured to send two EAIs, wherein when the two EAIs comprises a NACK EAI and a non-NACK EAI, the non-NACK EAI is used to indicate the resource index used by the UE, and another TTI type different from the TTI type requested by the UE, or a preset TTI type, when the two EAIs do not comprise a NACK EAI, the two EAIs are used to instruct the UE to execute a fallback operation.

16. A user equipment, comprising:
a preamble sending unit, configured to send an access preamble to a base station, wherein the access preamble carries a signature;
a configuration determining unit, configured to determine whether a cell where the user equipment (UE) is located is configured with an extended acquisition indicator (EAI); and
an indicator receiving unit, configured to receive, on an acquisition indicator channel (AICH) of an access timeslot corresponding to an access timeslot where the access preamble is sent, an acquisition indicator (AI) from the base station and corresponding to the signature of the access preamble; wherein
when a value of the AI is a first value, default resources associated with the signature of the access preamble which are used by the UE and a transmission time interval (TTI) type requested by the UE are indicated, or default resources associated with the AI corresponding to the signature of the access preamble which are used by the UE and a TTI type requested by the UE are allocated and indicated.

17. The user equipment according to claim 16, wherein when the cell where the UE is located is configured with no EAI and the value of the AI is a second value, rejection of an access request of the UE is indicated.

18. The user equipment according to claim 16, wherein when the cell where the UE is located is configured with an EAI and the value of the AI is the second value, the indicator receiving unit is configured to receive an EAI which indicates rejection of the access request of the UE, or indicates a resource index used by the UE and a TTI type, or instructs the UE to execute a fallback operation is received index.

19. The user equipment according to claim 16, wherein the indicator receiving unit is configured to receive an EAI which indicates rejection of the access request of the UE, or indicates a resource index used by the UE and a TTI type, or instructs the UE to execute a fallback operation is received index, comprises:
the indicator receiving unit is configured to receive one EAI, wherein when the EAI is NACK, the EAI is used to indicate rejection of the access request of the UE, or when the EAI is not NACK, the EAI is used to indicate a resource index used by the UE and mapped by the EAI and the TTI type requested by the UE.

20. The user equipment according to claim 16, wherein the indicator receiving unit is configured to receive an EAI which indicates rejection of the access request of the UE, or indicates a resource index used by the UE and a TTI type, or instructs the UE to execute a fallback operation is received index, comprises:
the indicator receiving unit is configured to receive two EAIs, wherein when the two EAIs comprises a NACK EAI and a non-NACK EAI, the non-NACK EAI is used to indicate the resource index used by the UE, and another TTI type different from the TTI type requested by the UE, or a preset TTI type, when the two EAIs do not comprise a NACK EAI, the two EAIs are used to instruct the UE to execute a fallback operation.
